(19) United States
(12) Patent Application Publication
(10) Pub. No.: US 2016/0275532 A1
(43) Pub. Date: Sep. 22, 2016

(54) SYSTEMS AND METHODS FOR ANALYZING AND DISPLAYING DATA

(71) Applicant: Adam Treiser, North Brunswick, NJ (US)

(72) Inventor: Adam Treiser, North Brunswick, NJ (US)

(21) Appl. No.: 14/442,393

(22) PCT Filed: Nov. 11, 2013
(86) PCT No.: PCT/US2013/069502

§ 371 Date: May 12, 2015

Related U.S. Application Data
(60) Provisional application No. 61/725,340, filed on Nov. 12, 2012.

(51) Int. Cl. G06Q 30/02; G06F 3/0481

(52) U.S. Cl. CPC G06Q 30/0204; G06Q 30/0201; G06F 3/0481

(57) ABSTRACT

The present disclosure generally relates to systems and methods for analyzing and displaying data. In accordance with one implementation, a computer-implemented method is provided that comprises displaying one or more personas. The method also includes displaying information associated with individuals within the persona and assigning and displaying a score to the persona which represents the persona's propensity to become a customer of a business. The displayed interface also may display characteristics associated with personas, relationships between personas, and geographical regions associated with personas. It may also display a communication display and provide a means for communicating with individuals and personas by way of a communication preference.

### CROSS-REFERENCE TO RELATED APPLICATIONS

This application claims the benefit of priority to U.S. Provisional Application No. 61/725,340 filed on Nov. 12, 2012, the entire content of which is expressly incorporated herein by reference in its entirety. The subject matter of U.S. patent application Ser. No. 13/461,670, issued as U.S. Pat. No. 8,341,101 is also incorporated by reference in its entirety.

### BACKGROUND

1. Technical Field

The present disclosure relates generally to systems and methods for analyzing and displaying large amounts of data. For example, and without limitation, systems and methods displaying data related to consumers.

2. Description of the Related Art

Customer profiling systems are known in the art. Traditional systems include consumer rewards cards, credit card purchase information, demographic profiling, behavioral profiling, and customer surveying. Some businesses supplement these traditional systems with website and social media analytic tools that profile the business's fans and followers according to factors such as “likes,” “click-through rates,” and search engine queries, among others. Generally, these systems attempt to determine products, promotions, and advertisements that are most likely to appeal to a specific customer or broad customer segment. This information helps businesses forecast future market behavior, manage their product portfolio and inventory levels, adjust product pricing, design marketing strategies, and determine human resource and capital investment needs in order to increase revenue, market share, and profitability. For example, advertising targeted at customers who are most likely to purchase a product may be more effective than advertising targeting broader audiences. Likewise, products that are related to one another are likely to be purchased by the same customer and may sell better if offered at the same time, whether as a package or as separate items. Online retailers often use a similar approach, suggesting items that other customers frequently purchase in conjunction with the selected item.

### SUMMARY

Various solutions exist for viewing and manipulating statistical information, such as customer profile data. But these tools typically do not allow users to easily identify relevant patterns, trends, and other important meanings from large volumes of information. Further, existing systems cannot respond to user manipulations, or provide information in real-time. Existing systems also do not provide users the ability to interact with the system from a mobile computing device. Thus, users cannot perform the type of analysis provided by these systems when and where it may be the most important.

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The present disclosure provides improved systems and methods for analyzing and displaying large quantities of data.

In accordance with some embodiments, improved techniques are provided for analyzing, manipulating, presenting, storing, sharing, managing, and displaying large amounts of data.

In additional embodiments, a computer-implemented method is disclosed for viewing existing and potential customers of a business who have similar characteristics. The method comprises displaying one or more personas, comprising groups of relationships between individuals and characteristics. The method further comprises determining a number of the individuals who are related to a persona and are also existing customers of a business. The method still further comprises displaying the number of the individuals who are related to the persona and are also existing customers of the business.

Some embodiments of this method may comprise determining a number of the individuals who are related to a persona and who are not existing customers of a business, and displaying the number of individuals related to the persona who are not existing customers of the business.

In accordance with additional embodiments of the present disclosure, a computer-implemented method is disclosed for viewing existing and potential customers of a business who have similar characteristics. The method comprises displaying one or more personas, comprising groups of relationships between individuals and characteristics. The method further comprises displaying the individuals and the characteristics related to at least one of the personas. The method still further comprises displaying a score for at least one of the personas. The method still further comprises receiving an updated score for at least one of the personas, and changing the displayed individuals and characteristics based on at least one of the updated scores.

Additional embodiments may also comprise displaying only the individuals associated with scores greater than or equal to the updated score, and displaying only the characteristics related to the displayed individual. The updated score may encompass a range of scores.

Some embodiments of this method may further comprise displaying only the individuals associated with scores that are within the updated range of scores, and displaying only the characteristics related to the displayed individuals.

In accordance with additional embodiments of the present disclosure, a computer-implemented method is disclosed for viewing existing and potential customers of a business who have similar characteristics. The method comprises displaying one or more personas, comprising groups of relationships between individuals and characteristics. It further comprises displaying information associated with the individuals who are related to the personas. The method still further comprises displaying a score for at least one of the personas.

The information in this method may include at least one of: products or services that the individuals related to the personas are likely to purchase, communication mediums that the individuals related to the personas are likely to use, geographic regions where the individuals related to the personas are located or are likely to make purchases from, a number of the individuals related to the personas who are related to a specific characteristic, a number of the individuals related to the personas who are related to the personas who are not existing customers of a business, or images representing the individuals related to the personas. The method further comprises changing the displayed images and characteristics, based on at least one of the updated scores.

In some embodiments, the products or services the individuals related to the personas are likely to purchase may comprise at least one of: products or services previously purchased by at least one of the individuals, products or services previously purchased by other individuals who are similar to at least one of the individuals, or products or services related to the products or services previously purchased by other individuals who are similar to at least one of the individuals.

In some embodiments, changing the displayed information may comprise displaying only the information associated with the individuals who are associated with scores that are equal to or greater than the updated score. The updated score may comprise a range of scores, and changing the displayed information may comprise displaying only the information associated with the individuals who are associated with scores within the updated range of scores.

In accordance with additional embodiments of the present disclosure, a computer-implemented method is disclosed for viewing a group of related characteristics. The method comprises displaying one or more personas, comprising groups of relationships between individuals and characteristics. The method further comprises receiving a selection of at least one of the personas. The method still further comprises displaying the individuals related to the selected persona. The method even further comprises determining categories of the characteristics. The method further comprises grouping the characteristics based on the categories. The method further comprises displaying the grouped characteristics comprising the selected persona.

Additionally, this method may comprise displaying a score for the selected persona, receiving an updated score, and dynamically changing the displayed information based on the updated score.

In some embodiments, dynamically changing the displayed information may further comprise displaying only the information related to the individuals associated with a score that is equal to or greater than the updated score. The updated score may comprise a range of scores, and dynamically changing the displayed information may further comprise displaying only the information related to the individuals associated with scores that are within the updated range of scores.

In accordance with additional embodiments of the present disclosure, a computer-implemented method is disclosed for displaying geographic regions of individuals related to specific groups of characteristics. The method comprises displaying a map. The method further comprises receiving a selection of at least one of the groups of characteristics. The method still further comprises identifying the individuals related to at least one of the selected groups who are also existing customers of a business. The method further comprises determining geographic regions related to the identified individuals, and displaying at least one of the determined geographic regions on the map.

According to some embodiments, the method may further comprise identifying the individuals associated with at least one of the selected groups who are also not existing customers of a business.

The method may also comprise assigning color to each of the selected groups and displaying at least one of the determined geographic regions on the map, using the colors assigned to all the groups related to that region.

In some embodiments, this method may also comprise receiving a selection of a region, and changing the map to show the selected region and displaying the individuals and the characteristics that are related to the groups in the selected region.

In accordance with additional embodiments of the present disclosure, a computer-implemented method of communicating with individuals related to specific groups of characteristics is disclosed. The method comprises receiving a group of characteristics. The method further comprises displaying the individuals related to the group. The method further comprises determining a communication preference for at least one of the individuals related to the group. The method still further comprises displaying at least one of the communication preferences. The method also comprises receiving a message to be sent to at least one of the individuals, and sending the message to at least one of the individuals, using the communication preference for that individual.

According to some embodiments, the method may further comprise determining which of the communication preferences the individual is likely to use, and sending the message to at the individual using the determined communication preferences.

Additionally, the method may further comprise determining which of the communication preferences the individual is likely to respond to and sending the message to the individual using the determined communication preferences.

In some embodiments, the communication preference may comprise email, SMS, MMS, phone, RMS, postal mail, or social media platforms such as Facebook, Twitter, or Linkedin.

In accordance with additional embodiments of the present disclosure, a computer-implemented method is disclosed for viewing sub-groups of relationships between individuals and characteristics. The method comprises receiving a request to view a group of relationships between individuals and characteristics. The method further comprises creating one or more sub-groups of the relationships, based on the characteristics. The method still further comprises outputting at least one of the sub-groups.

In accordance with additional embodiments of the present disclosure, a computer-implemented method is disclosed for viewing sub-groups of relationships between individuals and characteristics within a larger group. The method comprises receiving a request to view a group of relationships, wherein at least one of the relationships comprises a strength. The method further comprises receiving a threshold and creating one or more sub-groups of the relationships, based on the threshold and the strength. The method still further comprises outputting at least one of the sub-groups.

In accordance with additional embodiments of the present disclosure, a computer-implemented method is disclosed for automatically configuring administrative credentials on a remote system. The method comprises receiving a user request for administrative credentials on a remote system. The method further comprises receiving the user's account information. The method still further comprises accessing the remote system and requesting administrative privileges for the user. The method still further comprises determining what information is necessary to complete the user's request and sending the necessary information to the remote system.

In some embodiments, the method may further comprise receiving the user's credentials for an organization and sending the information regarding the organization and the user's credentials for an organization to the remote system.

According to some embodiments, the method may further comprise determining that the necessary information has not been provided and prompting the user to supply the necessary information.

For example, when first launching the application, downloading its software, or registering for a cloud-based version of the software, the user may be brought to an administration and setup page. Here, the user may enter their social media credentials for any of the social media platforms they would like included in the GUI, as well as the organization's name and all accompanying organizational credentials. The application may then automatically enter the information in the appropriate place on the user's admin page of each one of those social media platforms. At this time, the user may be prompted with information explaining that by proceeding he or she may be providing the GUI with administrative rights and access to such profile. This process may substantially reduce the burden on the user or their organization to provide such access by going through the actual steps for each social media platform individually and also provides the GUI with the ability to access all necessary information as any administrator could. Most importantly, all of this may be done without the user or the user's organization having to leave the GUI application.

In accordance with additional embodiments of the present disclosure, a computer-implemented method is disclosed for viewing relationships between two groups of relationships. The method comprises receiving a first group and displaying at least one of the relationships from the first group in a first region. The method further comprises receiving a second group and displaying at least one of the relationships from the second group in a second region. The method still further comprises determining which of the relationships are common to both the first group and the second group, and displaying the common relationships in a third region, indicating that they are common to both groups.

In some embodiments of the present disclosure, a computer-implemented method is disclosed for viewing sub-groups of relationships between two data elements. The method comprises receiving a group of relationships between the data elements and displaying at least one of the relationships from the group. The method further comprises receiving a request to split the group. The method still further comprises creating a first sub-group of relationships in the group, based on the strength of at least one of the relationships. The method further comprises creating a second sub-group of relationships in the group, based on the strength of at least one of the relationships.

According to some embodiments, this method further comprises displaying at least one of the relationships from the first sub-group in a first region, and displaying at least one of the relationships from the second sub-group in a second region.

Additionally, some embodiments of the method may further comprise identifying relationships that are common to both the first sub-group and the second sub-group and displaying at least one of the identified relationships in a third region.

The method may further comprise identifying a number of relationships that are common to both the first sub-group and the second sub-group and displaying the number in a third region.

In accordance with additional embodiments of the present disclosure, a computer-implemented method is disclosed for granting a user access to a system. The method comprises displaying a number of elements, comprising icons, colors, shapes, or alphanumeric symbols. The method further comprises receiving a selection of one of the elements and indicating that the element has been selected. The method still further comprises displaying a history of the selected elements, comprising the indications associated with each selected element. The method further comprises permitting access to the system, once the elements have been selected in a correct sequence. According to some embodiments, indicating that an element has been selected may comprise using a different indication for each element. The elements may comprise a color, shape, or alphanumeric symbol. The method may further comprise identifying the user associated with the correct sequence and loading the identified user's information.

In accordance with additional embodiments of the present disclosure, a computer-readable medium is disclosed that operates to perform at least one of the foregoing disclosed methods.

In accordance with additional embodiments of the present disclosure, a system is disclosed for manipulating and displaying data on remote devices. The system comprises an analysis server, for gathering data and determining a number of relationships. The system further comprises one or more data sources, from which the analysis server receives data. The system further comprises a user terminal, for displaying data and relationships to a user. The user terminal may comprise a general-purpose computer, such as a laptop, a cell phone, a tablet, or a server. The user terminal may comprise multi-purpose software running on a remote device. The multi-purpose software may comprise a web browser. The user terminal may comprise application software running on a remote device. The user terminal may retrieve data from the analysis server, and manipulate data locally on the user terminal. The user terminal may request the analysis server to analyze data stored on the analysis server, and receive only the results of the analysis.

Further features or variations may be provided in addition to those set forth herein. For example, the present invention may be directed to various combinations and sub-combinations of the disclosed features, or combinations and sub-combinations of several further features disclosed below in the detailed descriptions.

### BRIEF DESCRIPTION OF THE DRAWINGS

The accompanying drawings, which are incorporated in and constitute a part of this specification, illustrate several embodiments of the present disclosure and together with the description, serve to explain the principles of the disclosed embodiments.

FIG. 1 is a block diagram of an exemplary embodiment of a system for analyzing and displaying data.

FIG. 2 is an exemplary persona display.

FIG. 3 is an exemplary communication display.

FIG. 4 is an exemplary geographic region display.

FIG. 5 is an exemplary relationship display.

FIG. 6 is a flowchart of an exemplary method for displaying data.

FIG. 7 is a flowchart of an exemplary method for communicating with individuals.

FIG. 8 is a flowchart of an exemplary method for displaying geographic regions related to personas.

FIG. 9 is a flowchart of an exemplary method for displaying relationships between personas.

FIG. 10 is a flowchart of an exemplary method for allowing users access to a secured system.

### DETAILED DESCRIPTION OF EXEMPLARY EMBODIMENTS

Reference will now be made in detail to embodiments of the present disclosure, examples of which are illustrated in the accompanying figures. The discussion will use the same reference numbers included in the drawings to refer to the same or like parts. It is apparent, however, that the embodiments shown in the accompanying drawings are not limiting, and that modifications may be made without departing from the spirit and scope of the invention.

In this disclosure, the use of the singular includes the plural, unless specifically stated otherwise. Also, in this disclosure, the use of “or” means “and/or,” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

Embodiments of the present disclosure provide improved systems and methods for analyzing and displaying large amounts of data. Specifically, the present disclosure provides systems and methods for viewing, manipulating, presenting, storing, sharing, and managing large amounts of statistical information. The underlying concepts related to the calculation of relationship values and scores, as used in the presently disclosed methods and systems, is discussed at length in U.S. patent application Ser. No. 13/461,670, issued as U.S. Pat. No. 8,341,101, which is hereby incorporated by reference. The embodiments presented in the present disclosure are related to analyzing and visually displaying the data in a meaningful and easy-to-understand way.

The system for analyzing and displaying data is a characteristic-based system. A characteristic-based system may define a number of characteristics. As used herein, the term characteristic broadly refers to any attribute, trait, value, or other factor associated, whether objectively or subjectively, with an individual or group of individuals. The detailed description below provides further examples of such characteristics. When receiving information about an individual, the characteristic-based system may use a suitable relationship-determining module (i.e., a software component, a hardware component, or a combination of a software component and a hardware component) comprising relationship-determining algorithms known in the art to determine the relationship between the information and the characteristics. This relationship may be described using both a magnitude and a direction. Further, the description may be represented by a numerical value, textual identifier, graphical icon, color, opacity, or any other suitable method of representing the relationship. The magnitude may represent how strongly the information is related to the characteristics, including the lack of any relationship at all.

The system may also receive a plurality of descriptors, identifying or describing specific individuals. The system may use a similar relationship-determining module to identify which individual, or individuals, are the most strongly related to the information. In this way, the system may further determine the relationship between the individuals and the characteristics. These relationships may be accumulated over time to develop a better understanding of the individual, based on multiple data points.

Further, the system may use the relationship-determining modules to identify new relationships and patterns in the data. The system may use these relationships and patterns to create new characteristics, which will be used when evaluating the received data. Likewise, over time the system may identify characteristics that generally do not relate to the data. It may flag these characteristics as irrelevant with respect to certain data or relationships. The system may then skip the irrelevant characteristics, increasing performance.

The system may also use the relationship-determining module to identify characteristics that are related to each other. The system may group these related characteristics together into personas. A title may be given to this persona. As used herein, the term persona refers to a group of relationships between individuals and characteristics. The system may use the relationship-determining module to determine the relationships between the groups of characteristics or personas and the characteristics, data, individuals, and the other groups of characteristics. In this manner, personality types may be identified and analyzed.

In addition, the system may receive a metric, representing an overall goal or interest of a particular organization. As used herein, the term metric broadly refers to any attribute, measurement, goal, strategy, or other information of interest to an organization. The metric may also consist of a number of sub-metrics. As used herein, the term sub-metric broadly refers to any attribute, measurement, goal, strategy, or other information related to the metric. The system may use a suitable relationship-determining module to identify the relationship between the metric and the characteristics. In this way, the system may further determine the relationship between the metrics and the individuals. The system may also determine the relationship between groups of characteristics and the metric, personas and the metric, and individuals and the metric. In this manner, the organization may gain information on how personality types or individuals contribute to the metric it is interested in. In additions, the system may compute a score. The score may reflect the average propensity of the individuals who fit within a persona to also fit within a metric or sub-metric. Thus, the score reflects the likelihood that an individual within a persona would also fit within the desired attributes, goals, strategies, or other information of interest to an organization, for example being likely to purchase an organization's products.

Further, a visualization module (i.e., a software component, a hardware component, or a combination of a software component and a hardware component) may be used to develop a representation of any relationship, group of relationships, or personas. The user may select two areas of interest. The selections may comprise one or more metrics, sub-metrics, personas, characteristics, groups of characteristics, individuals, data items, data sources, or any grouping of the same. Once both selections have been made, the system may use the relationships for those selections to calculate an overall relationship between the two. The system may then represent this overall relationship as a single value or descriptor. Further, the user may assign weights to one or more of the selection items, or change the assigned weights. When the weights are changed, the system may re-calculate all relationships and values associated with the weights. The system may use these weights accordingly when calculating the overall relationship between the selections. The system may also determine the relationships between one selection and the underlying items comprising the other selection. The system may then compute a single value or descriptor for the underlying items. In this manner, the user is able to determine how the underlying items contribute to the overall relationship between the selections.

The system may also receive a plurality of threshold criteria. As used herein, the term threshold criteria broadly refers to any value, score, term, event, or descriptor related to one or more data items, data sources, individuals, characteristics, groups of characteristics, relationships, groups of relationships, or personas. The threshold criteria may represent a specific event, (e.g., an individual has changed their job description), a keyword (e.g., an advertising keyword was mentioned in a blog post), a value (e.g., a relationship is at, above, or below the criteria), a transaction (e.g., an individual has booked a flight), or any other criteria about which the organization wishes to be informed. The system may output notifications when any threshold criteria are met.

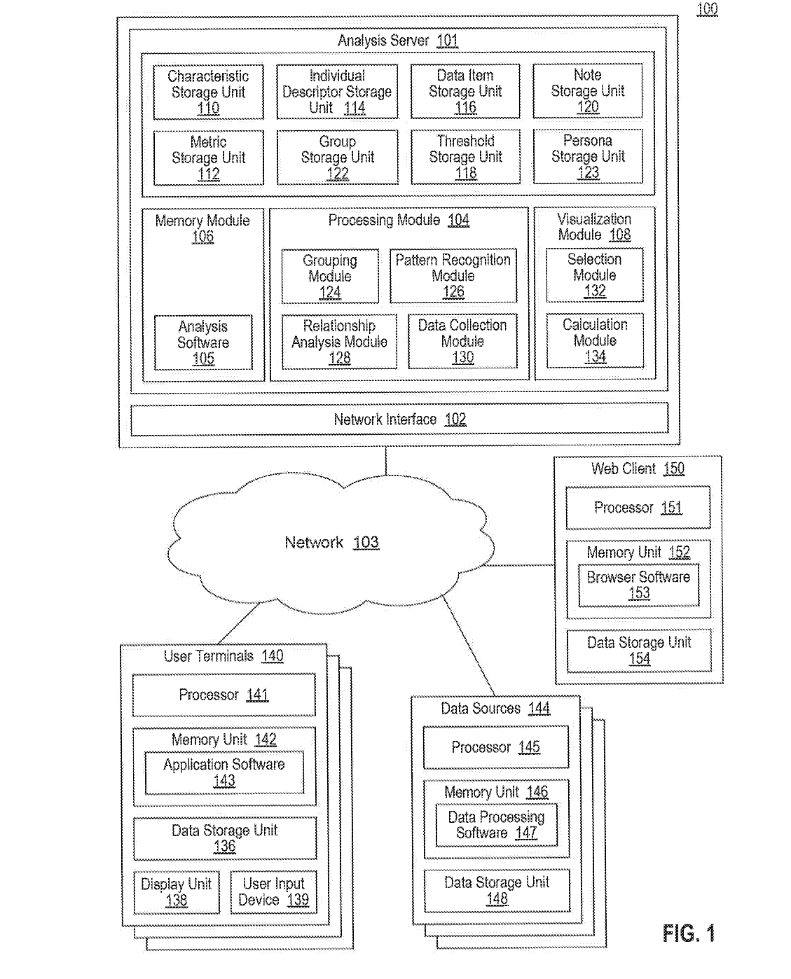

FIG. 1 is a block diagram of an exemplary embodiment of a system 100 for analyzing and displaying data. One skilled in the art will appreciate that system 100 may be implemented in a number of different configurations without departing from the spirit and scope of the present invention. System 100 may include an analysis server 101, a network interface 102, a network 103, user terminals 140, data sources 144, and a web client 150.

As shown in FIG. 1, analysis server 101 may include a network interface 102, a memory module 106, a processing module 104, a visualization module 108, and one or more interconnected information storage units, such as, for example, a characteristic storage unit 110, a metric storage unit 112, an individual descriptor storage unit 114, a data item storage unit 116, a threshold criteria storage unit 118, a note storage unit 120, a group storage unit 122, and a persona storage unit 123. While the information storage units are illustrated in FIG. 1 as interconnected, each information storage unit need not be interconnected. Moreover, rather than separate storage units, analysis server 101 may include only one database that would include the data of storage units 110-123. Likewise, while the data storage units are shown as part of server 101, in another embodiment, one or more storage units may be separate units, connected to analysis server 101 through network interface 102.

Network interface 102 may be one or more devices used to facilitate the transfer of information between analysis server 101 and external components, such as user terminals 140, data sources 144, and web client 150. Network interface module 102 may receive user requests from a user terminal 140, and route those requests to processing module 104 or visualization module 108. The user terminals 140 may be either local user terminals or remote user terminals. The data sources 144 may also be local data sources or remote data sources. In exemplary embodiments, network interface module 102 may be a wired or wireless interface to a local-area network connecting one or more local user terminals 140 and local data sources 144, or to a wide-area network such as the Internet, connecting one or more remote user terminals 140, or remote data sources 144. Network interface module 102 may allow a plurality of user terminals 140, local or remote or both, to connect to the system, in order to make selections and receive information, alerts, and visualizations consistent with this disclosure. Network interface module 102 may also allow the system to connect to one or more data sources 144, local or remote or both, by way of local area networks or wide area networks, to connect to the system 100.

Memory module 106 may represent one or more non-transitory computer-readable storage devices that maintain information that is used by processing module 104 and/or other components internal and external to characteristic-based server 100. Memory module 106 may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. Further, memory module 106 may include analysis software 105 that, when executed by processing module 104, perform one or more processes consistent with embodiments of the present invention. Memory module 106 may also include configuration data that may be used by processing module 104 to present user interface screens and visualizations to user terminals 140.

Analysis software 105 may be leveraged by the processing module 104 to connect with remote systems, such as data sources 144, via network interface 102, to extract data using standard interfaces and protocols such as HTTP, HTTPS, RSYNC, FTP, IMAP and SMTP, oAuth, or others. In one embodiment, the analysis server 101 need not store the data. Rather, the content may remain at a remote location, such as the data storage unit 148 of data source 144. The analysis software 105 may cache a limited subset of data in, for example, the data item storage unit 116, and reference the source of record when necessary to get the content. The analysis software 105 may also continuously synch with the data sources 144 to maintain up-to-date data. In another embodiment, the analysis server 101 may obtain copies of the data from data sources 144, and store these copies in data item storage unit 116. In a third embodiment, data may be entered directly into the analysis server 101, and stored in data item storage unit 116. The analysis software 105 may also store metadata, synthesized data, and transformed data in data item storage unit 116.

Analysis software 105 may also process the data, through module 104, to determine the relationships between the data elements, as discussed in detail below. These relationships may also be stored in data storage units 110-123. Analysis software 105 may also respond to requests received from user terminals 144 and web client 150. In response to these requests, analysis software 105 may leverage the processing module 104 to calculate new relationships between the data elements, groups of data elements, and/or existing relationships. Analysis software 105 may send data elements, relationships, personas, groups, metrics, etc. to user terminal 140 or web client 150, through network 103. Analysis software 105 may also store a record of what information has been sent, in order to send only the information that is new or has changed.

Processing module 104, as shown in FIG. 1, may include one or more processors for processing data according to analysis software 105 stored in memory module 106. The functions of each processor may be provided by a single dedicated processor or by a plurality of processors. Processing module 104 may further include a data collection module 130, a grouping module 124, a pattern recognition module 126, and a relationship analysis module 128. Data collection module 130 may include components for collecting data items from data sources, using network interface 102. As described in more detail below, data items collected by the data collection module may include any information pertaining to an individual. Relationship analysis module 128 may include components for determining the existence and strength of a relationship between two items. For example, and as described in greater detail below, relationship analysis module 128 may include a natural-language processing component for determining the relationship between two items. Grouping module 124 may include components for identifying groups of related items. For example, and as described in greater detail below, grouping module 124 may use relationships identified by relationship analysis module 128 to identify groups of related items. Pattern recognition module 126 may include components for identifying patterns in the received data. For example, and as described in greater detail below, pattern recognition module 126 may include pattern recognition algorithms known in the art to identify new characteristics based on patterns of received data.

As shown in FIG. 1, analysis server 101 may also include a plurality of interconnected storage units, 110-123. In this regard, analysis server 101 may include a storage unit module (not shown) having components for controlling access to storage units 110-123. Such a storage unit module may include a query function that, in response to a match request, may query information stored in one or more of storage units 110-123 to identify characteristics, personas, data items, or metrics meeting specified criteria. Storage units 110-123 may be configured using any appropriate type of unit that facilitates the storage of data, as well as the locating, accessing, and retrieving of data stored in the storage units.

Characteristic storage unit 110 may store general characteristics of individuals. As used herein, the term characteristic broadly refers to any attribute, trait, value, or other factor associated, whether objectively or subjectively, with an individual or group of individuals or persona. For example, a characteristic may reflect a number of attributes that may be applicable to one or more individuals, such as types of previously or currently held fields of work (e.g., salesperson), professional or personal values (e.g., environmentalism), location (e.g., New York), social interactions (e.g., trendsetter), emotional traits (e.g., generally negative), user-defined characteristics, or others.

Data item storage unit 116 may store data collected by data collection module 130. Data item storage unit 116 may also store metadata associated with the data items, describing the data items. For example, metadata may include the data source the data item was collected from, the time the data item was posted or created, the time the data item was collected, the type of data item (e.g., a blog post), or the individual with which the data is associated. Data item storage unit 116 may also store data items received, or created by analysis server 101.

Metric storage unit 112 may store metrics and sub-metrics for an organization. As used herein, a metric broadly refers to any measurement, criteria, goal, or information of interest to an organization. For example, a given organization may be interested in a “brand awareness” metric, or how likely a given person is to recognize the organization's brand. The metric may also be comprised of sub-metrics. As used herein, a sub-metric refers to any information further characterizing a metric. For example, sub-metrics further characterizing brand awareness may include “internet mentions” for that brand, how widely those mentions are distributed, how the mentions describe the brand, number of sales, or others.

Persona storage unit 123 may store personas. As used herein, the term persona refers to a group of relationships between individuals and characteristics. Personas may be determined by the relationship-analysis module 128 or by the grouping module 124. The organization of individuals into personas based on their relationship to characteristics allows users to more easily identify and understand, manipulate, and analyze categories of individuals.

Individual descriptor storage unit 114 may store descriptors of specific individuals. As used herein, an individual descriptor includes any information that identifies a specific individual, as opposed to a group of people. Descriptors may include names, addresses, employee numbers, driver's license numbers, credit card and other banking account information, social security numbers, behavioral profiles, relationship or social network information, linguistic styles or writing, voice recognition, image recognition or any other unique identifiers. In this manner, each descriptor or group of descriptors may be used to identify a unique individual.

Threshold criteria storage unit 118 may store the threshold criteria used to determine when a notification should occur. Threshold criteria may include any value, term, event, or descriptor related to one or more data items, data sources, individuals, characteristics, groups of characteristics, or relationships. The threshold criteria may represent a specific event, (e.g., an individual has changed their job description), a keyword (e.g., an advertising keyword was mentioned in a blog post), a value (e.g., a relationship is at, above, or below the criteria), a transaction (e.g., an individual has booked a flight), or any other criteria about which the organization wishes to be informed.

Note storage unit 120 may store notes, comprising information entered by one or more users, that are associated with one or more individual descriptors, groups, relationships, personas, metrics, sub-metrics, data items, or data sources. The information may include textual, graphical, audio, or video information. For example, a user may enter a textual description of a specific group or persona, such as the “treehugger” group. This description may allow users to more easily refer to, and understand the characteristics that comprise that group.

Group storage unit 122 may store groups, consisting of a plurality of characteristics, or other groups. These groups may allow users to more easily identify and understand categories of individuals.

Visualization module 108, as shown in FIG. 1, may further include a selection module 132 and a calculation module 134. Selection module 132 may include components for receiving user selections from network interface module 102. For example, selection module 132 may allow users on user terminals 140 to make selections. User selections may consist of one or more individual descriptors, metrics, sub-metrics, characteristics, groups, personas, data items, data sources, or groups thereof. Calculation module 134 may include components for determining the relationships between the selected groups or personas and the remaining groups, personas, data items, metrics, sub-metrics, characteristics, data sources, and individuals. This may include using the relationships to calculate an overall relationship for a group with respect to the other groups, personas, data items, metrics, characteristics, data sources, and individuals. This may also include using the relationships to calculate an overall relationship for a persona with respect to the other groups, personas, data items, metrics, characteristics, data sources, and individuals. Calculation module 134 may also receive weights associated with a group, persona, data item, metric, sub-metric, characteristic, data source, or individual, and use the weights in conjunction with the stored relationships when determining the overall relationship for a selection. Visualization module 108 may use the calculated values for a selection to build a screen containing at least one selection, and a representation of the overall relationship between that selection and at least one other selection. Calculation module 134 may also receive scores associated with personas, and use the scores in conjunction with the stored metrics for determining the relationship between personas and metrics. Visualization module 108 may also include additional information about the selection in the screen. For example, and as discussed in more detail below, selection module 132 may receive a selection of an individual and a selection of a metric. Calculation module 134 may determine the overall relationship between the individual and metric based on the stored relationships. Visualization module 108 may return a screen containing information about the individual and a single descriptor of the overall relationship. Further, selection module 132 may receive a selection of a persona. Calculation module 134 may determine the score for the persona. Visualization module 108 may return a screen containing information about the persona and the calculated score.

Data collection module 130 may be configured to collect data from data sources 144. Data collection module 130 may optionally comprise search engine tools known in the art, operable to find data sources 144 and data items relevant to the search criteria, such as an individual or a persona.

Analysis server 101 may comprise a single computer or mainframe, containing at least a processor, memory, storage, and may either contain or be connected to a network interface 102. Analysis server 101 may optionally be implemented as a combination of instructions stored in software, executable to perform the steps described below, and a processor connected to the software, capable of executing the instructions. Alternatively, analysis server 101 may be implemented in a number of different computers, connected to each other either through a local-area network (LAN) or wide-area network (WAN). Storage units 110-123 may comprise any computer-readable medium known in the art, including databases, file systems, or data sources.

Data sources 144 may contain a processor 145, a memory unit 146, and a data storage unit 148. Data sources 144 may comprise internal data sources (e.g. crm, payroll, etc.), privately-shared sources (e.g., suppliers, partners, etc.), user-authorized data sources (e.g., social media accounts, etc.), public data sources (e.g., blogs, tweets, etc.), or purchased data sources (e.g., data aggregators, credit card db, etc.). As discussed above, the purchased data sources may also contain characteristics, metrics, or individual descriptors. In another embodiment, the system may only access data from sources that have been marked as relevant for one or more individual descriptors, metrics, groups, or sub-metrics.

Data storage unit 148 may also include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. Data storage unit 148 may contain data items. Data items may be both structured and unstructured data. Data items may also qualitative and subjective, quantitative and objective, or a combination of both. Structured data broadly refers to any data that is placed into a pre-existing structure such as a database, spreadsheet, or form. Unstructured data broadly refers to data that does not have a defined structure, such as prose, news articles, blog posts, comments, messages, emoticons, images, video, audio, or other freely-entered data. Quantitative and objective data broadly concerns factual, measurable subjects. For example, quantitative data may be described in terms of quantity, such as a numerical value or range. In comparison, qualitative and subjective data broadly describes items in terms of a quality or categorization wherein the quality or category may not be fully defined. For example, qualitative and subjective data may describe objects in terms of warmth and flavor.

Memory unit 146 may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. Memory unit 146 may include data processing software 147. Data processing software 147 may leverage the processor 145 to gather and transmit data stored in data storage unit 148 to analysis server 101 through network interface 102 over network 103.

Processor 145 may include one or more processors for processing and transmitting data according to data processing software 147 stored in memory unit 146. Processor 145 may interface with the analysis server 101 through network interface 102 over network 103. The processor may gather and transmit data to the analysis server 101.

User terminals 140 may include a processor 141, memory unit 142, data storage unit 136, a display unit 138, and a user input device 139. User terminals 140 may comprise a general-purpose computer, such as a laptop, a cell phone, a tablet, or a server.

Memory unit 142 may comprise any type of RAM or ROM embodied in a physical storage medium, such as magnetic storage including floppy disk, hard disk, or magnetic tape; semiconductor storage such as solid state disk (‘SSD’) or flash memory; optical disc storage; or magneto-optical disc storage. Memory unit 142 may include application software 143.

Application software 143 may include a web browser for interfacing with the web client 150. The application software 143 may further include software for interfacing with the analysis server 101 through the network interface 102 over the network 103. Application software 143 may send requests to the analysis server 101. These requests may be requests to send data, or may be requests to have the analysis server 101 manipulate data and send only the results. Application software 143 may also leverage processor 141 to manipulate data received from the analysis server 101 on user terminal 140. Application software 143 may further include a browser, e-mail client, messaging client, application or any other instructions for presenting content to a user. In one embodiment, application software 143 may be an application installed on the mobile device. In this embodiment, application software 143 may be implemented using one or more technologies such as Objective C, C, C++, Java, C#, or others. In another embodiment, application software 143 may provide a web browser, similar to browser software 153, discussed in detail later. Application software 143 may provide one or more graphical user interfaces to display the data and for the user to select, manipulate, enter, and/or view information, as described in detail below.

Processor 141 may include one or more physical hardware processors for interfacing with analysis server 101 or with web client 150. Processor 141 may be further configured to locally manipulate data retrieved from analysis server 101. Processor 141 may manipulate data locally on the user terminal 144, and may also request that the analysis server 101, through processing module 104, analyze data stored in the storage units 110-123. In this scenario, processor 141 may receive only the results of the analysis from analysis server 101.

Data storage unit 136 may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. Data storage unit 136 may be configured to store data received by processor 141 from the analysis server 101. Data storage unit 136 may further be configured to store the results of data analysis conducted by processing module 104 in the analysis server 101.

Display unit 138 comprises a screen for displaying a user interface. Display unit 138 may be configured to display the appropriate user interface to allow a user at user terminal 140 to view data and results in the desired fashion. The details of the various user interfaces that may be viewed on the display are discussed in detail below.

User input device 139 may comprise a keyboard, touch screen, and/or mouse. User input device 139 is configured to allow a user to interface with user terminal 140 and application software 143 as previously described. User input device 139 may allow a user to request data from the analysis server 101, to locally manipulate data stored in data storage unit 136, and to view the data and results in the desired fashion on display unit 138.

Web client 150 may include a processor 151, a memory unit 152, and a data storage unit 154. Web client 150 may be configured to be accessed directly be a user, or by a user through a user terminal 140. Web client 150 may be used similarly to a user terminal, for remotely accessing the analysis server 101 over network 103. Web client 150 may further include a display unit and/or user input device (not shown) similar to those described with reference to the user terminals 140.

Memory unit 152 may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. Memory unit 152 may store browser software 153 for execution by processor 151.

Browser software 153 may be implemented using one or more technologies such as JAVA, Apache/Tomcat, Ruby on Rails, Perl, Python, etc. Browser software 153 may include a set of instructions executable by a processor to provide the methods, features, and interfaces disclosed herein. Browser software 153 may allow a user to manipulate and view data stored in analysis server 101 over network 103. Browser software 153 may further provide one or more graphical user interfaces for the user to select, manipulate, enter, and/or view information, as described in the attached Appendices. The graphical user interface may also allow the user to request additional information, or enter metadata, notes, reminders, or other information.

Processor 151 may include one or more processors for interfacing with analysis server 101 or with user terminals 140. Processor 151 may be further be configured to locally manipulate data. The processor 151 also may request that the analysis server 101, through processing module 104, analyze data stored in the storage units 110-123. In this scenario, processor 151 would only receive only the results of the analysis.

Data storage unit 154 may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. Data storage unit 154 stores at least a portion of the data and/or instructions for implementing the methods, features, and interfaces provided by browser software 153. The web client may either contain or be remotely connected to data storage unit 154. Data storage unit 154 may store data received from analysis server 101, or may store the results of data manipulation conducted by processing module 104 in analysis server 101.

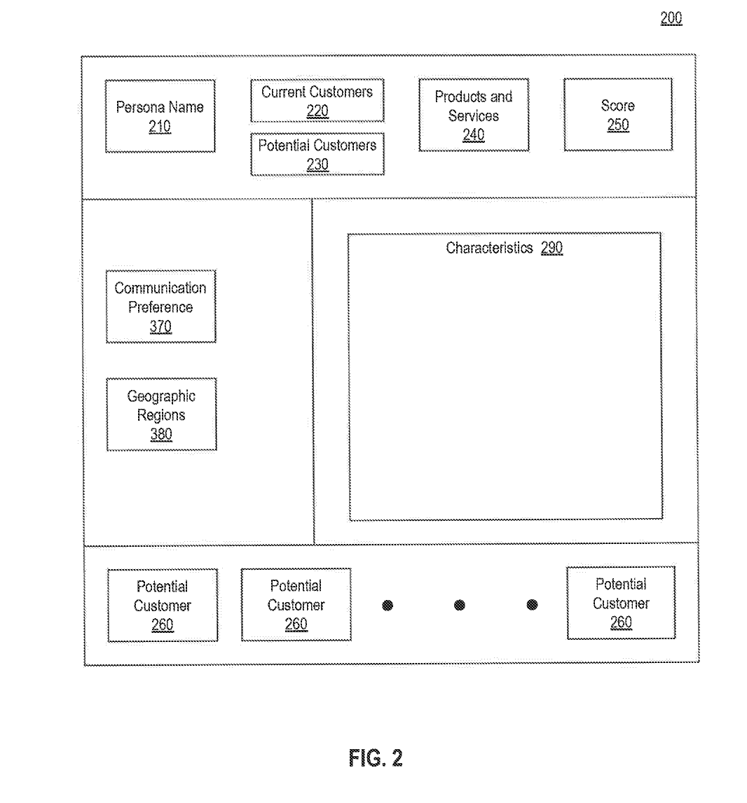

FIGS. 2-6 illustrate exemplary embodiments of displaying data in a user interface. The user interface may be a part of application software 143 or browser software 153, as discussed previously. The user interface may be displayed on display unit 138, if being displayed at user terminal 140.

FIG. 2 shows an exemplary persona display 200. Persona display 200 provides a way to display a persona. The persona display 200 may include the persona name 210, a number of existing customers 220, a number of potential customers 230, products and services 240, a score 250, characteristics 290, potential customers 260, communication preferences 270, and geographic regions 280. The displayed data may be stored in storage units 110-123, in data storage unit 136 in user terminal 140, or in data storage unit 154 in web client 150.

Persona name 210 identifies the displayed persona (e.g., “Military Spouses”).

Number of existing customers 220 and number of potential customers 230 may be determined by processing module 104, or may be determined locally by either processor 141 in user terminal 140 or processor 151 in the web client 150. Further, this data may be retrieved directly by the data collection module 130 from data sources 144. This data may be stored in storage units 110-123, or within data storage unit 136 of user terminal 140 or data storage unit 154 of web client 150.

Displayed products and services 240 comprise products and/or services that individuals of the displayed persona are likely to purchase. The displayed products or services 240 that the individuals are likely to purchase may be based on each individual's previous purchases, or products or services that are related to, or similar to, that individual's previous purchases. The displayed products or services 240 may also be based on products or services purchased by other individuals who are related to individuals of the displayed persona, or may be based on products and services that are related to, or similar to, products and services purchased by individuals related to individuals of the displayed persona. Lastly, the displayed products and services 240 may be based on other behavior indicating that individuals of the displayed persona are likely to purchase a product, such as placing a product in a shopping cart, searching for a product online, adding a product or service to a wish list, or any other behavior that indicates an individual is considering the product or service. The products or services 240 may be determined by processing module 104, or may be determined locally by either processor 141 in the user terminal or processor 151 in the web client. Further, this data may be retrieved directly by the data collection module 130 from data sources 144. This data may be stored in data item storage unit 116, or within data storage unit 136 of user terminals 140 or data storage unit 154 of web client 150.

Score 250 may reflect the average propensity of the individuals who fit within that persona to become a customer or to otherwise take the action desired, such as purchasing products or services. Score 250 may be calculated by analysis server 101, and more specifically by relationship analysis module 128 within processing module 104.

Displayed characteristics 290 are characteristics related to individuals within the displayed persona. Characteristics 290 may reflect a number of attributes, such as types of previously or currently held fields of work (e.g., salesperson), professional or personal values (e.g., environmentalism), location (e.g., New York), social interactions (e.g., trendsetter), emotional traits (e.g., generally negative), user-defined characteristics, or others. Characteristics 290 may be determined by processing module 104, or may be determined locally by either processor 141 in user terminal 140 or processor 151 in the web client 150. Further, this data may be retrieved directly by the data collection module 130 from data sources 144. This data may be stored in characteristic storage unit 110, or within data storage unit 136 of user terminals 140 or data storage unit 154 of web client 150.

Communication preferences 270 may reflect the individuals' preferences for receiving communications. Communication preferences 270 may comprise, for example, email, SMS, MMS, phone, RMS, postal mail, or social media platforms such as Facebook, Twitter, or Linkedin.

Geographic regions 280 may reflect the geographic regions associated with individuals within the persona, such as the regions where they reside, make frequent purchases from, work, etc.

Potential customers 260 may reflect individuals within the displayed persona who are not existing customers of a business, but who are likely to become existing customers, or who may otherwise be of interest to a business. People who may be of interest to a business may include people who would be valuable customers, even if they are not likely to become existing customers. Other people who may be of interest to a business may also include, in some circumstances, people unlikely to become existing customers of a business. This may give a user the ability to analyze and understand individuals who are unlikely to become existing customers. Potential customers 260 may be displayed, for example, as pictures of individuals.

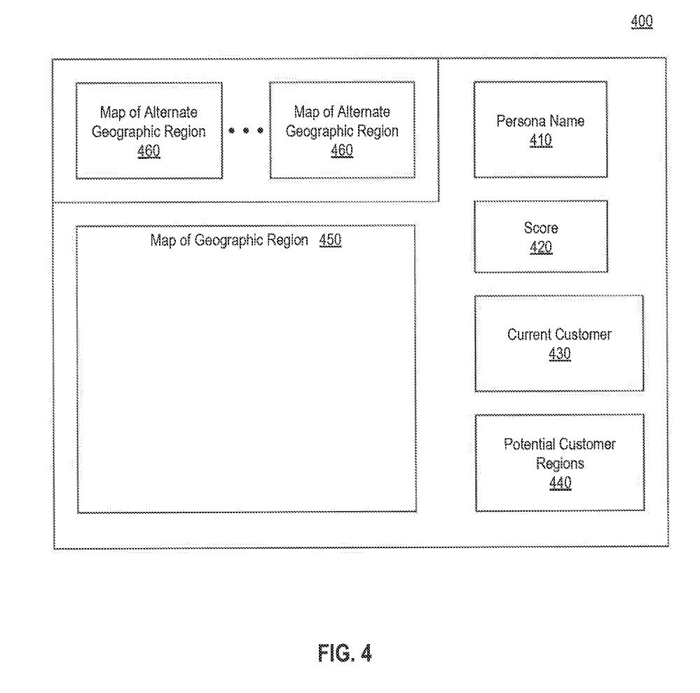

Potential customers 260, communication preferences 270, and geographic regions 280 represent visualization tools. Each of these components may be selected by the user, for example by utilizing user input device 139. When selected by the user) these tools may allow a user to change to a different user interface display. For example, selecting geographic regions 280 may prompt the user interface to display the geographic location display 400, shown in FIG. 4 and discussed in detail below.

In some embodiments, score 250 may be updated based on the user's selections. For example, a user may select one or more of the displayed products or services 240 by providing input through user input device 139 (FIG. 1). If the user's selection would result in a new score, different than the score currently displayed, score 250 will change. For example, selecting one or more products or services may result in a higher score, based only on the selected products or services. Score 250 may then be changed to reflect the new score. Other information on display 200 may also be changed, so that only information related to score 250 is displayed. For example, information related to score 250 may include information with a score equal to, above, or below score 250, or within the range of score 250. These changes may allow the user to understand how the overall score for a persona is influenced, and/or focus only on information related to a certain score, or range of scores. For example, changing to a higher score may cause only those individuals who are likely to purchase the selected product or service to be displayed. The user may also change the score directly by selecting the score itself. The user may then be prompted to enter a new score using, for example, user input device 139. For example, a user may select a new score that is higher than the currently displayed score 250. Based on the user's selected score, score 250 may change, as well as any other information on display 200 including characteristics 290, current customers 220, potential customers 230, and potential customers 260. In this manner, a user may filter the displayed information, for example in order to only display those individuals within a persona that have a higher propensity to become a customer or take a desired action. In this manner, a user's selections may easily filter the displayed information, so that only the most relevant information is displayed.

The display shown in FIG. 2 may allow a user to quickly understand the type of individuals who fall within a persona, how much of a business' customer base consists of people falling within a persona, how much growth potential a given persona has, the products or services the individuals characterized by this persona are likely to purchase. Some embodiments may also allow a user to determine whether the persona is trending up or down, meaning growing or shrinking in terms of size, and the extent of such a trend. In some embodiments, the user may be able to alter the displayed data to see how to maximize the value provided by each persona. For example, by selecting specific products or services or by updating the score, a user may be easily able to manipulate and understand the data.

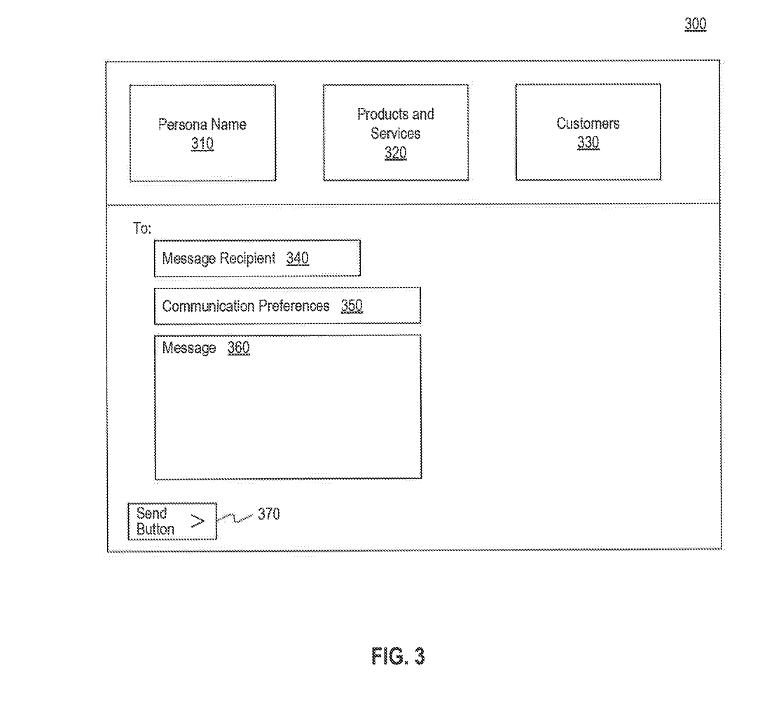

FIG. 3 shows an exemplary communications display 300. Communications display 300 provides a way for a user to view the communications preferences of an individual, group of individuals, or a persona. It further allows users to send communications to individuals, groups of individuals, or personas. The groups of individuals may be a filtered group of individuals. The filtering may be done on by the processing module 104 or by processor 141 in user terminal 140 or by processor 151 in web client 150. For example, a filtered group of individuals may comprise only those individuals with selected characteristics. Likewise, a filtered group of individuals may comprise only those individuals with a score above a certain threshold regardless of what persona they fit into.

The communications display 300 may include the persona name 310, a number of customers 330, products and services 320, message recipients 340, communication preferences 350, and a message 360. The displayed data such as persona name 310, number of customers 330, products and services 320, and communication preferences 350, may be stored in storage units 110-123, in data storage unit 136 in user terminal 140, or in data storage unit 154 in web client 150. Additional data, such as geographic location, characteristics, and score, may also be displayed on communications display 300.

Persona name 310, products and services 320, and number of customers 330 reflect the same data as may be displayed on a persona display 200, as shown in FIG. 2 and previously discussed in detail. Products and services 320 and number of customers 330 are data items related to the displayed persona name 310.

Message recipients 340 include the individuals to whom the communication will be sent. Message recipients 340 could be a persona, an individual, or a group of individuals, as discussed above.

The communication preferences 350 for the selected individual, group of individuals, or persona may be displayed. Communication preferences 350 may include, for example, email, SMS, MMS, phone, RMS, postal mail, or social media platforms such as Facebook, Twitter, or Linkedin. Communication preferences 350 comprise the selected individuals' preferences for receiving communications. The user may select one or more desired communication preferences from the communication preferences 350, via which the message will be sent. For example, once the user selects a communication preference 350, the system may then automatically create an RSS feed, JSON file, CSV file, or other necessary file of each individual and his/her respective email address, Twitter handle, or mailing address and feed that information directly into user's marketing platform, such as Eloqua, Constant Contacts, Mail Chimp, Twilio, or any other similar platforms. If these or similar platforms are not used then the user may send a message directly to the message recipients 340 directly from the communications display using the selected methods. In some embodiments, the communication preferences 350 may be ranked (e.g., in order of most likely to be effective to least), for each message recipient. Thus, if a user selects more than one communication preference 350, the system may only communicate with each individual using the highest ranked preference that was chosen.

Message 360 may comprise a text box or other region into which a user may enter the desired message to be communicated to the message recipients 340. The user may be able to input the message by using, for example, user input device 139 at user terminal 140.

Send button 370 may be selected by the user to prompt the system to send message 360 to the selected individuals via the selected communication preferences 350. In some embodiments, the system may give feedback to the user that the message has been sent successfully, after the selection of send button 370. This feedback may be, for example, a visual on-screen notification or an audio tone.

In additional embodiments, the communications display 300 may enable a user to send communications to colleagues. The communications display 300 may further enable a user to program the titles, roles, or names, of specific colleagues (not shown) into message recipient 340 portion of the display. Having programmed titles may make it easier for a user to send a message to the correct recipient. A user will not have to worry about typing in the address to send the message, but instead can select from a pre-programmed list. Because the user will not have to bother typing in a full address, there is no risk of mistakenly mistyping the recipient's name or address and sending the message to an incorrect location.

FIG. 4 shows an exemplary geographic region display 400. Geographic region display 400 provides a way for users to graphically display the geographic region data related to the individuals within a persona. Geographic region display 400 may include a persona name 410, a score 420, existing customer regions 430, potential customer regions 440, a map of a geographic region 450, and one or more maps of alternate geographic regions 460. The displayed data such as persona name 410, and score 420 may be stored in storage units 110-123, in data storage unit 136 in user terminal 140, or in data storage unit 154 in web client 150. Additional data, such as characteristics and/or products and services may also be displayed on geographic region display 400. Persona name 410 and score 420 are the same data as persona name 210 and score 250 in persona display 200, as shown in FIG. 2 and previously discussed in detail.

Existing customer regions 430 may comprise a list of geographic regions and the number of existing customers within the displayed persona 410 associated with each region. This data may be stored in storage units 110-123, in data storage unit 136 in user terminal 140, or in data storage unit 154 in web client 150. Existing customer regions 430 may be determined by relationship analysis module 128 or grouping module 124.

Potential customer regions 440 may comprise a list of geographic regions and the number of potential clients within the displayed persona 410 associated with each region. This data may be stored in storage units 110-123, in data storage unit 136 in user terminal 140, or in data storage unit 154 in web client 150. Potential customer regions 430 may be determined by relationship analysis module 128 or grouping module 124.

Map 450 comprises a map of a geographic region where existing or potential customers reside, are likely to make purchases from, work, etc. Map 450 may be a broad geographic region (i.e. country, continent) or may be a narrower geographic region (i.e. state, county, city, neighborhood). Specific geographic regions where existing or potential customers reside may also be displayed within a broader geographic region, and may be displayed as circles around specific geographic regions on map 450. Further, the user may be able to zoom in on a specific location, for example by reverse pinching, using a slider or a scroll wheel, or by selecting a specific circle or specific region on map 450. In some embodiments, the circles or specific regions may be color-coded to represent personas. Each circle may represent a single persona. Therefore, this display may be configured to display multiple personas on the same map 450. Further, arch circle may have multiple colors, representing various personas that are found in each location. In some of these embodiments, the colors may be represented as segments of a pie chart.

Maps of alternate geographic regions 460 may also be displayed. Alternate maps 560 may show different geographic regions from across the globe where individuals within the displayed persona 410 may also reside. By selecting one of these alternate geographic regions, the user may change the map 450 displayed. In some embodiments, if there is an issue or pattern which the user should be alerted of, within a region in an alternate map 460 the alternate map 460 may glow and/or blink to indicate to the user that he or she may wish to select an alternate region 460.

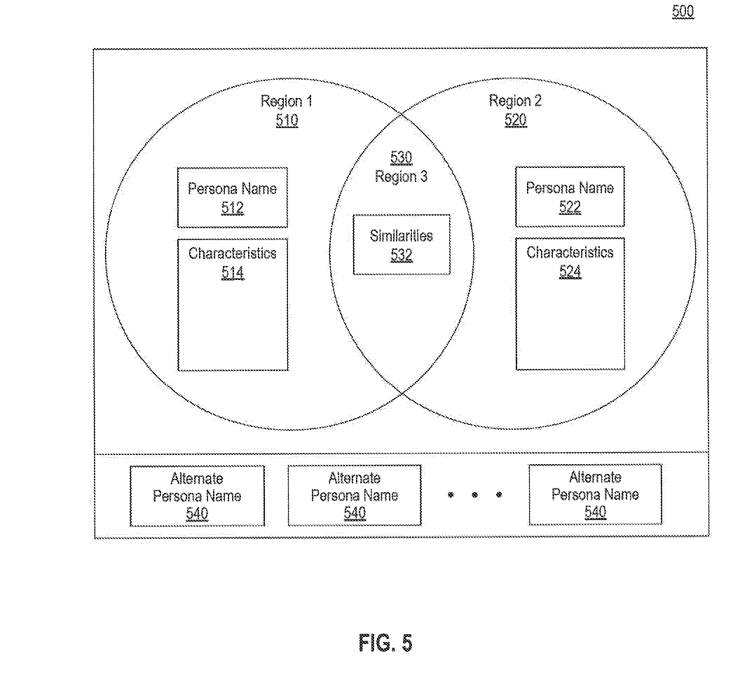

FIG. 5 shows an exemplary relationship display 500. Exemplary relationship display 500 displays data about two or more personas and displays the similarities between them. Exemplary relationship display 500 may include at least two persona names 512 522, at least three regions 510 520 530, and alternate persona names 540.

Region one 510 displays one persona name 512 and the characteristics 514 associated with persona name 512. The characteristics 514 may be stored in characteristic storage unit 110, data storage unit 136 in user terminal 140, or data storage unit 154 in web client 150. Processing module 104, processor 141 in user terminal 140, or processor 151 in web client 150 determine which characteristics are associated with persona name 512. Region one 510 may be displayed as a circle, but could also be any other geometric shape.

Region two 520 displays a second persona name 522 and the characteristics 524 associated with persona 522. The characteristics 524 may be stored in characteristic storage unit 110, data storage unit 136 in user terminal 140, or data storage unit 154 in web client 150. Processing module 104, processor 141 in user terminal 140, or processor 151 in web client 150 determine which characteristics are associated with persona 522. Region two 520 may be displayed as a circle, but could also be any other geometric shape.

Regions one 510 and two 520, may be displayed as a Venn Diagram, so that an overlapping region three 530 is created by the overlap. Region three 530 may display common information such as similarities 532 between the displayed personas 512 522. Similarities 532 may comprise any type of similarities between the two regions, for example the characteristics that are exhibited by both personas 512 522. Pattern recognition module 126 may determine the similarities between the displayed personas 512 522. The similarities 532 displayed in region three 530 may be displayed as an integer value (i.e. “4 Similarities”). Alternatively, the similarities 532 may be displayed as the actual characteristics that are shared by both displayed persona. In another example, region three 530 may display the number of individuals, or actual individuals, that may be existing customers, potential new customers, or both, that have been, are, or have a strong likelihood of being grouped into both the displayed personas. Grouping module 124, for example, may determine the number of individuals that have been, are, or have a strong likelihood of being grouped into both the displayed personas.

Alternate personas 540 may also be displayed in the relationship display 500. Alternate personas 540 may be selected by the user to replace either persona 512 or persona 522, or may be selected to add an additional persona to the display. Alternate personas 540 may glow or blink in order to identify that there may be significant relationships between the information currently displayed with respect to the selected persona and the information that would be displayed if the user chose the glowing or blinking persona. Significant relationships may be determined by the relationship analysis module 128 within the analysis server 101 based on the data stored in storage units 110-123. Glowing or blinking alternate personas 540 prevent a user from wasting time trying to find relationships that may or may not exist between personas and the information that is associated with respect to such personas.

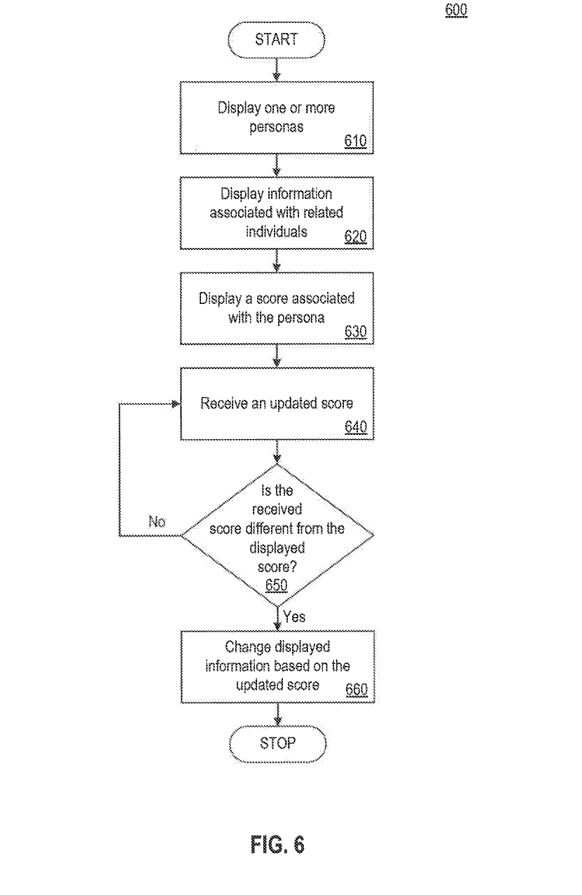

FIG. 6 is a flowchart of an exemplary method for viewing a persona 600. The exemplary method 600 may be performed by a computer processor executing instructions encoded on a computer-readable medium storage device. The method may be implemented in system 100 shown in FIG. 1. For example, the method may be implemented in the visualization module 108, in user terminal 140, or in web client 150.

In step 610, a system may display one or more personas. For example, the interface display shown in FIG. 2.

In step 620, the system may display information associated with related individuals. For example, FIG. 2 shows an exemplary user interface displaying characteristics 290, products and services 240, potential customers 260, communication options 270, and geographic regions 280 related to the displayed persona. Also displayed with respect to the persona may be the number of existing customers and/or the number of potential customers within the persona.

In step 630, the system may display a score associated with the persona. The score may reflect the propensity (e.g., an average propensity) of the individuals who fit within that persona to become a customer or to otherwise take the action desired by the business, such as purchasing products or services, as discussed in detail previously. The score may be displayed as shown in FIG. 2.

In step 640, the system may receive an updated score. Step 650 determines whether the score received in step 640 is different than the score that is presently being displayed. If the received score is different than the presently displayed score, step 660 updates the displayed score to reflect the received score. Steps 640, 650, and 660 may be repeated to accommodate multiple score updates as requested by the user. The user may request score updates through the user input device 139 of the user input terminal 640, through the web client 650, or through the selection module 132.

In step 660, the system may change the displayed information based upon the updated score. For example, the displayed information may be updated to only show the information relevant to the individuals within the persona who meet the updated score criteria.

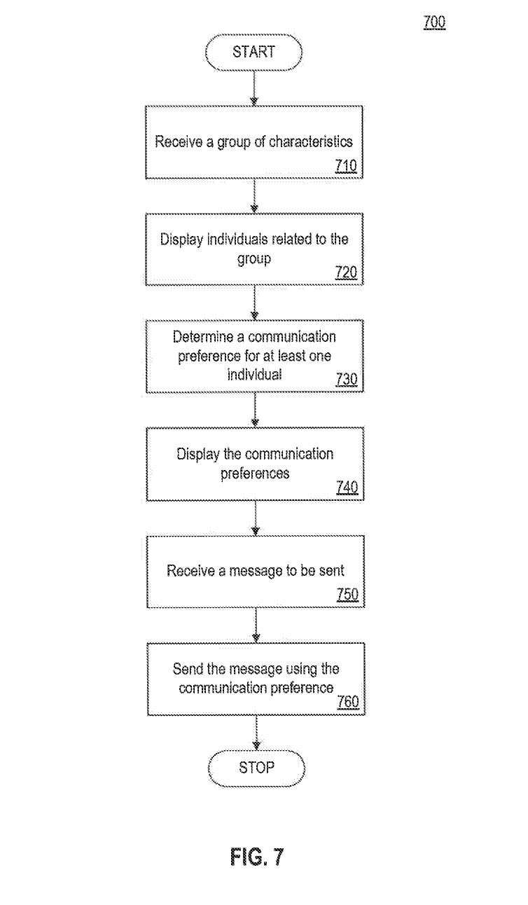

FIG. 7 is a flowchart of an exemplary method for communicating with individuals 700. The exemplary method 700 may be performed by a computer processor executing instructions encoded on a computer-readable medium storage device. The method 700 may be implemented in system 100 shown in FIG. 1. For example, the method may be implemented in the visualization module 108, in user terminal 140, or in web client 150.

In step 710, the system may receive a group of characteristics. Grouping module 124 may configure the group of characteristics. The group of characteristics may be received by the analysis server 101 from data sources 144. The group of characteristics may also be received by the user terminal 140 or web client 150 from the characteristic storage unit 110 within the analysis server 101.

In step 720, the system may display the individuals related to the group of characteristics. The relationship analysis module 128 may determine which individuals are related to the particular group of characteristics. The data may be displayed by the user interface, as discussed previously.

In step 730, the system may determine a communication preference for at least one individual. This determination may be made by the processing module 104, or by processors 141 or 151 in the user terminal 140 or web client 150, respectively. The communication preference related to the at least one individual may be stored in storage units 110-123 within the analysis server, or may be stored in data storage units 136 or 154 in the user terminal 140 or web client 150, respectively.

In step 740, the system may display the communication preference or preferences for the at least one selected individual. The communication preference or preferences may include, for example, email, SMS, MMS, phone, RMS, postal mail, or social media platforms such as Facebook, Twitter, or Linkedin. The communication preferences may reflect the selected individual's preferred method of communication.

In step 750, the system may receive a message to be sent. The message may be input by the user, for example using the user input device 139. As shown in FIG. 3, the message may be entered into a message box or text box.

In step 760, the system may send the message using the communication preference. If more than one communication preference is determined for the individual, the user may select the desired communication preference for sending the message. Once the user makes a selection, the system may then automatically create an RSS feed, JSON file, CSV file, or other necessary file of each individual and his/her respective email address, Twitter handle, or mailing address and feed that information directly into user's marketing platform, such as Eloqua, Constant Contacts, Mail Chimp, Twilio, or any other similar platforms. If these or similar platforms are not used then the user may send a message directly to the individual using the selected preference. In some embodiments, if more than one communication preference is determined, the communication preferences may be ranked (e.g., in order of most likely to be effective to least), for each message recipient. In this embodiment, the system may only communicate with each individual using the highest ranked preference.

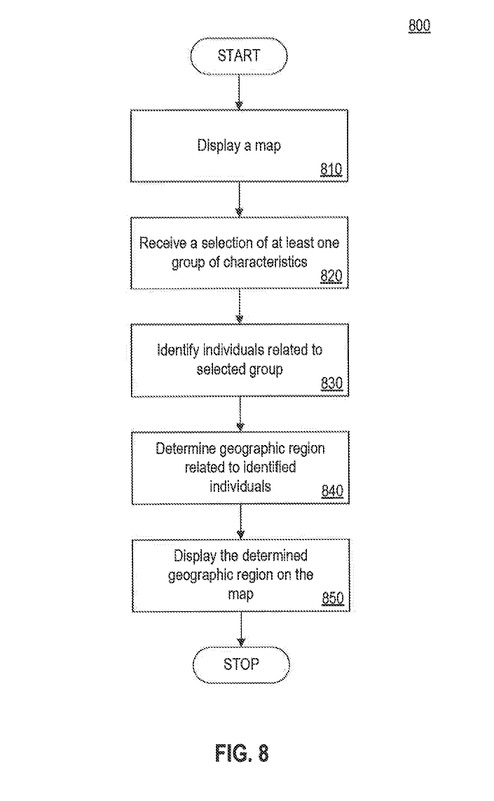

FIG. 8 is a flowchart of an exemplary embodiment of a method for displaying geographic regions 800. The exemplary method 800 may be performed by a computer processor executing instructions encoded on a computer-readable medium storage device. The method 800 may be implemented in system 100 shown in FIG. 1. For example, the method may be implemented in the visualization module 108, in user terminal 140, or in web client 150.

In step 810, the system may display a map. In some embodiments, the user may select a geographic location that may be displayed on a persona display, as shown in FIG. 2, in order to prompt the system to display a map. Alternatively, the map that is displayed in step 810 may be that which is most relevant to the user. For example, if the user generally focuses on a specific region, then a map of that region may load initially upon entering the geography view. Data indicating which region a particular user may focus on may be stored, for example, in data storage unit 136 on user terminal 140 or in data storage unit 154 in web client 150. Alternatively, if the user generally focuses on a specific persona, then a map of the geographic region with information most pertinent to the persona may be displayed in step 810. Data indicating which persona a particular user may focus on may be stored, for example, in data storage unit 136 on user terminal 140 or in data storage unit 154 in web client 150.

In step 820, the system may receive a selection of at least one group of characteristics. The group of characteristics may be characteristics related to a persona. The characteristics related to a persona may be stored, for example, in characteristic storage unit 110, and accessed by processing unit 104.

In step 830, the system may identify individuals related to the selected group. Data indicating which individuals are related to the selected group of characteristics may be stored, for example, in individual descriptor storage unit 114 or in characteristic storage unit 110. This data may be accessed and analyzed by processing module 104, and more specifically by relationship analysis module 128, to determine which individuals are related to the group of characteristics.

In step 840, the system may determine the geographic region related to the identified individuals. Data indicating which individuals are related to the selected group of characteristics may be stored, for example, in individual descriptor storage unit 114 or in characteristic storage unit 110. This data may be accessed and analyzed by processing module 104.

In step 850, the system may display the determined geographic region on the map. The determined geographic region may be displayed as circles around specific geographic regions on the map displayed in step 810. Further, the user may be able to zoom in on a specific location, for example by reverse pinching, using a slider or a scroll wheel, or by selecting a specific circle or specific region on map. In some embodiments, the circles or specific regions may be color-coded to represent groups of characteristics. Each circle may represent a single group. Therefore, this display may be configured to display multiple groups on the same map. In additional embodiments, each circle may have multiple colors, representing various groups that are found in each location.

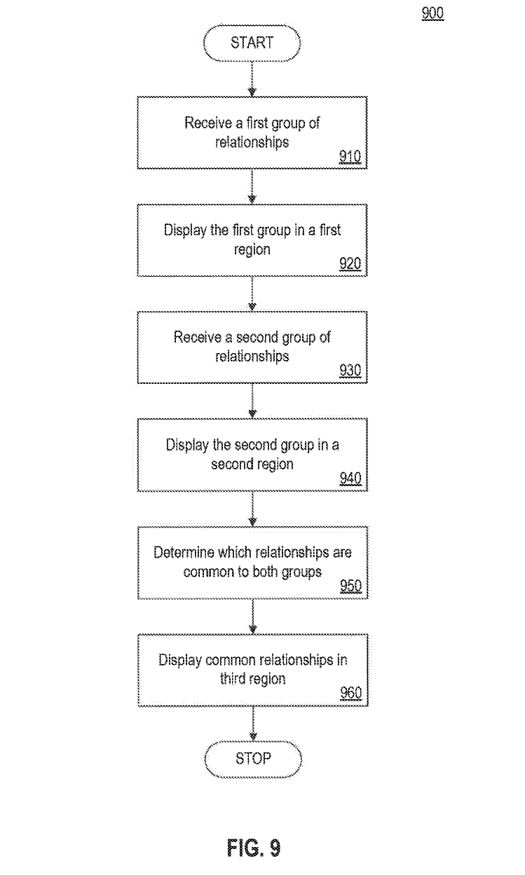

FIG. 9 is a flowchart of an exemplary method for viewing relationships 900. The exemplary method 900 may be performed by a computer processor executing instructions encoded on a computer-readable medium storage device. The method 1000 may be implemented in system 100 shown in FIG. 1. For example, the method may be implemented in the visualization module 108, in user terminal 140, or in web client 150.

In step 910, the system may receive a first group. The group may be, for example, a group of relationships, a persona, a group of individuals, or a group of characteristics. The received group may be stored, for example, in characteristic storage unit 110 or persona storage unit 123. This information may be accessed and supplied by processing module 104.

In step 920, the system may display the first group in a first region. The first region may be a circle, but could also be any other geometric shape.

In step 930, the system may receive a second group. The second group may be, for example, a group of relationships, a persona, a group of individuals, or a group of characteristics. The second group may be stored, for example, in characteristic storage unit 110 or persona storage unit 123. This information may be accessed and supplied by processing module 104.

In step 940, the system may display the second group in a second region. The second region may be a circle, but could also be any other geometric shape.

In step 950, the system may determine items that are common or related to both groups. The common items may, for example, comprise the relationships that are exhibited by both the groups displayed in regions one and two. Pattern recognition module 126 or relationship analysis module 128, for example, may determine the common items to be displayed in region three.

In step 960, the system may display the common items in a third region. The first and second regions may be displayed as a Venn Diagram, so that the third region is created by the overlap. An exemplary display is shown in FIG. 5, discussed in detail above.

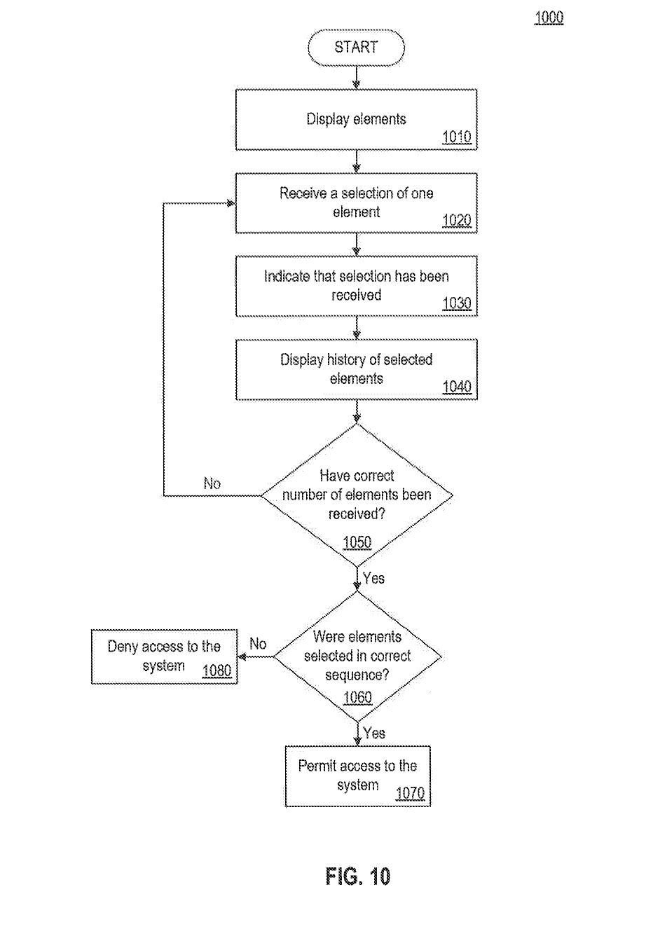

FIG. 10 is a flowchart of an exemplary method for allowing users access to a secured system 1000. The exemplary method 1000 may be performed by a computer processor executing instructions encoded on a computer-readable medium storage device. The method 1000 may be implemented in system 100 shown in FIG. 1. For example, the method may be implemented in the visualization module 108, in user terminal 140, or in web client 150. Method 1000 may be implemented, for example, on analysis server 101, user terminal 140, or web clients 150 to allow a user access to system 100.

In step 1010, the system may display elements. The elements may be letters, numbers, images, and/or colors. In one embodiment, the elements may be large, easy-to-read, and easy-to-select icons.

In step 1020, the system may receive a selection of one element. The selection may be made by the user, for example, by using the user input device 139.

In step 1030, the system may indicate that the selection has been received. The selection may be indicated by immediately, and for a somewhat lengthy period of time, flashing a bright color. The bright and lengthy flash may allow the user to easily identify which element has been selected. This visual indication may be displayed, for example, on display unit 138. Additionally, an auditory indication may be given to the user. The auditory indication may be a signal or tone.

In step 1040, the system may display a history of the selected elements. In some embodiments, the history may be placed at the bottom of the screen, or in another reserved location. The history of selected elements may make it easier for the user to identify which element has been selected. The history of selected elements may show how many elements need to be selected, and also show how many elements have been selected so far.

Step 1050 tests whether the correct number of selected elements has been received by the system. If the correct number of selected elements has been received, step 1060 then tests if the selected elements were entered in the correct sequence. If the correct number of selected elements has been received in the correct sequence, the system may then allow access to the user. If the correct number of selected elements has not been received, the system repeats beginning at step 1020, and receiving an additional selection of one element. If the correct number of selected elements has been received, but the elements were not selected in the correct sequence, in step 1080, the system may deny the user access.

The present disclosure of a method for accessing a secured system may be easier on the user's eyes. It may make it easier for the user to select each element as a result of its size. The combination of elements may also be easier for a user to remember, while still maintaining necessary security standards, by using a pattern that results from a combination of number, letters, images, and colors. The present disclosure may also remove the username requirement.

In some examples some none or all of the logic for the above-described techniques may be implemented as a computer program or application or as a plug in module or sub component of another application. The described techniques may be varied and are not limited to the examples or descriptions provided. In some examples applications may be developed for download to mobile communications and computing devices, e.g., laptops, mobile computers, tablet computers, smart phones, etc., being made available for download by the user either directly from the device or through a website.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

It is intended, therefore, that the specification and examples be considered as exemplary only. Additional embodiments are within the purview of the present disclosure and sample claims.

1. A computer-implemented method for viewing existing and potential customers of a business who have similar characteristics, comprising;
displaying one or more personas, comprising groups of relationships between individuals and characteristics;
determining a number of the individuals who are related to a persona and are also existing customers of a business; and
displaying the number of the individuals who are related to the persona and are also existing customers of the business.

2. The method of claim 1, further comprising:
determining a number of the individuals who are related to a persona and who are not existing customers of a business; and
displaying the number of individuals related to the persona who are not existing customers of the business.

3.-37. (canceled)

38. A computer-readable medium that includes operations to perform a method for viewing existing and potential customers of a business who have similar characteristics when executed with a processor, the operations comprising:
displaying one or more personas, comprising groups of relationships between individuals and characteristics;
determining a number of the individuals who are related to a persona and are also existing customers of a business; and
displaying the number of the individuals who are related to the persona and are also existing customers of the business.

39. The computer-readable medium of claim 38, further comprising operations for:
determining a number of the individuals who are related to a persona and who are not existing customers of a business; and
displaying the number of individuals related to the persona who are not existing customers of the business.

40.-81. (canceled)

82. The method of claim 1, further comprising:
displaying the individuals and the characteristics related to at least one of the personas;
displaying a score for at least one of the personas;
receiving an updated score for at least one of the personas; and
changing the displayed individuals and characteristics, based on the updated score.

83. The method of claim 82, wherein changing the displayed individuals and characteristics comprises displaying only the individuals associated with scores greater than or equal to the updated score, and displaying only the characteristics related to the displayed individuals.

84. The method of claim 82, wherein the updated score comprises a range of scores, and changing the displayed individuals and characteristics comprises displaying only the individuals associated with scores that are within the updated range of scores, and displaying only the characteristics related to the displayed individuals.

85. The method of claim 1, further comprising
displaying information associated with the individuals who are related to the personas;
displaying a score for at least one of the personas;
receiving an updated score for at least one of the personas; and
changing the displayed information, based on the updated score.

86. The method of claim 85, wherein the information associated with the individuals related to the personas comprises at least one of:
products or services that the individuals related to the personas are likely to purchase;
communication mediums that the individuals related to the personas are likely to use;
geographic regions where the individuals related to the personas are located or are likely to make purchases from;
a number of the individuals related to the personas who are related to a specific characteristic;
a number of the individuals related to the personas who are existing customers of a business;
a number of the individuals related to the personas who are not existing customers of a business; or
images representing the individuals related to the personas.

87. The method of claim 86, wherein products or services that the individuals related to the personas are likely to purchase comprise at least one of products previously purchased by at least one of the individuals, products related to products that at least one of the individuals has previously purchased, products previously purchased by other individuals who are similar to at least one of the individuals, or products related to products previously purchased by other individuals who are similar to at least one of the individuals.

88. The method of claim 85, wherein changing the displayed information comprises displaying only the information associated with the individuals who are associated with scores that are equal to or greater than, the updated score.

89. The method of claim 85, wherein the updated score comprises a range of scores, and changing the displayed information comprises displaying only the information associated with the individuals who are associated with scores within the updated range of scores.

90. The computer-readable medium of claim 38, further comprising operations for:
displaying the individuals and the characteristics related to at least one of the personas;
displaying a score for at least one of the personas;
receiving an updated score for at least one of the personas; and
changing the displayed individuals and characteristics, based on the updated score.

91. The computer-readable medium of claim 90, wherein changing the displayed individuals and characteristics comprises displaying only the individuals associated with scores greater than or equal to the updated score, and displaying only the characteristics related to the displayed individuals.

92. The computer-readable medium of claim 90, wherein the updated score comprises a range of scores, and changing the displayed individuals and characteristics comprises displaying only the individuals associated with scores that are within the updated range of scores, and displaying only the characteristics related to the displayed individuals.

93. The computer-readable medium of claim 38, further comprising operations for:
displaying information associated with the individuals who are related to the personas;
displaying a score for at least one of the personas;
receiving an updated score for at least one of the personas; and
changing the displayed information, based on the updated score.

94. The computer-readable medium of claim 93, wherein the information associated with the individuals related to the personas comprises at least one of:
products or services that the individuals related to the personas are likely to purchase;
communication mediums that the individuals related to the personas are likely to use;
geographic regions where the individuals related to the personas are located or are likely to make purchases from;
a number of the individuals related to the personas who are related to a specific characteristic;
a number of the individuals related to the personas who are existing customers of a business;
a number of the individuals related to the personas who are not existing customers of a business; or
images representing the individuals related to the personas.

95. The computer-readable medium of claim 94, wherein products or services that the individuals related to the personas are likely to purchase comprise at least one of products previously purchased by at least one of the individuals, products related to products that at least one of the individuals has previously purchased, products previously purchased by other individuals who are similar to at least one of the individuals, or products related to products previously purchased by other individuals who are similar to at least one of the individuals.

96. The computer-readable medium of claim 93, wherein changing the displayed information comprises displaying only the information associated with the individuals who are associated with scores that are equal to or greater than, the updated score.

97. The computer-readable medium of claim 93, wherein the updated score comprises a range of scores, and changing the displayed information comprises displaying only the information associated with the individuals who are associated with scores within the updated range of scores.
